(19) United States
(12) Patent Application Publication
(10) Pub. No.: US 2010/0305957 A1
(43) Pub. Date: Dec. 2, 2010

(54) METHOD AND SYSTEM OF REDEEMING GOLD FOR CASH OR OTHER VALUE

(76) Inventors: Roger Parsons, Farmington Hills, MI (US); Rick Dollinger, Columbiaville, MI (US)

Correspondence Address: John S. Artz;Dickinson Wright PLLC, Ste. 2000, 38525 Woodward Ave, Bloomfield Hills, MI, 48304-2970, US

(21) Appl. No.: 12/476,582

(22) Filed: Jun. 2, 2009

(51) Int. Cl. G06Q 30/00; G06K 5/00

(52) U.S. Cl. 705/1.1; 235/380

(57) ABSTRACT

A method and system of allowing a consumer to exchange gold for monetary consideration includes the step of a consumer obtaining a submission kit from a retailer. The submission kit includes a package having a unique identifier thereon. The consumer places the gold item into the package and then sends it to a third party processor along with information about the consumer. The third party processes and evaluates the gold item and determines its monetary value. A settlement statement is then sent to the consumer advising them as to the monetary value and seeking instruction from the consumer as to how the consumer wishes to proceed with the exchange of the gold item they submitted in order to complete the transaction. If selected, a gift card is then sent to the consumer, which can be utilized at the retailer's store.

### TECHNICAL FIELD

The present invention relates generally to a method and system of exchanging gold for monetary consideration. More particularly, the present invention relates to a method and system of exchanging gold for monetary consideration, including a gift card for use at a particular retail location.

### BACKGROUND INFORMATION

Gold has always been a valuable commodity. This is particularly true today as the price of gold has escalated over the past couple of years. The demand for gold is very high. Consequently, companies have developed programs that allow individuals to exchange unwanted gold items or other items made from precious metals for cash. An example of such an existing company is one that offers its services at the domain name www.cash4gold.com.

These programs typically work by having an individual or consumer contact the company to obtain a submission kit. Each kit has an identifier and provides instructions to the individual as to how to package and submit their gold items for exchange. In general, the individual puts the gold item into a return kit or package and then sends it to the company from whom they obtained the kit for valuation Once the kit is received by the company, it is opened and the customer tracking number is noted and recorded such that the gold item is associated with the submitter. Alternative programs do not utilize kits to facilitate sending in the gold item Instead, with these alternate programs, the consumer simply sends the gold item directly to the company without a kit.

In accordance with these known programs, once the gold item is received, it is processed and weighed. The material is then tested to determine its precious metal content. Based on this information, a cash value is determined for the precious metal item sent in by the individual. Thereafter, the company advises the individual as to the monetary value they will receive if they elect to complete the transaction. If the individual elects to complete the transaction, the company will issue a check in the amount of the determined cash value to the individual who submitted the item. Alternatively, if instructions are provided by the individual, the company can directly deposit the cash into the individual's bank account or other location. If the individual elects not to complete the transaction, they can the item returned.

Other cash for gold systems are known. While there may be some differences between the various known programs, they all operate in substantially the same fashion. Specifically, they generally involve a two party transaction, i.e. a transaction between an individual who has a gold item and the entity who receives the gold item from the individual, valuates the gold item, and then sends cash directly to the individual. These programs do not allow a consumer options as to how to receive payment for the gold item. Further, these types of programs require direct interaction between the individual and the entity. As is also known, when dealing with individuals and cash, complaints can frequently arise which can bring unwanted attention and publicity to a company. For example, complaints can occur over the way these companies have valuated the gold items they receive. These systems thus do not allow a company who deals with gold to interact with customers in an anonymous fashion. Additionally, these systems do not provide the consumers with options that can engender greater trust in the quality of the service they will receive.

### SUMMARY OF THE INVENTION

It is therefore an advantage of the present invention to provide an improved method and system of allowing a consumer to exchange gold for monetary consideration, which keeps the identity of the entity relatively anonymous.

It is a further advantage of the present invention to provide a method and system of allowing a consumer to exchange gold for monetary consolidation, which involves multiple parties to complete the transaction.

It is another advantage of the present invention to provide a method and system of allowing a consumer to exchange gold for monetary consideration, where the consideration is a gift card that can be utilized at a particular retailer's location.

It is a related advantage of the present invention to provide a method and system of allowing a consumer to exchange gold for a gift card that can be utilized at a particular retailer's location and where the gift card has a monetary value thereon equal to the value of the gold item plus an additional amount equal to a predetermined percentage of the determined gold value.

It is still another advantage of the present invention to provide a method and system of allowing a consumer to exchange gold for monetary consideration that allows a consumer to obtain a kit for the redemption of a gold item from a retailer's location.

It is yet another advantage of the present invention to provide a method and system of allowing a consumer to exchange gold for monetary consideration that provides the consumers with options and flexibility as to how to complete the transaction.

In accordance with the above and the other advantages of the present invention, a method and system of allowing a consumer to exchange gold for monetary consideration is provided. Initially, a consumer obtains a submission kit from a retailer. The submission kit includes a package having a unique identifier thereon. The consumer places the gold item into the package and sends it to a third party processor along with information about the consumer. The third party processor processes and evaluates the gold item and then determines its monetary value. A statement is then sent to the consumer advising as to the monetary value and seeking instruction from the consumer as to how they wish to complete the transaction. If selected by the consumer, they can receive a gift card, which can be utilized at the retailer's store.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a block diagram of the parties involved in the method of exchanging gold for compensation in accordance with a preferred embodiment of the present invention;

FIG. 2 is a block diagram of the process of exchanging gold for compensation in accordance with a preferred embodiment of the present invention;

FIG. 3 is a schematic illustration of the process of exchanging gold for compensation in accordance with preferred embodiment of the present invention; and

FIG. 4 is a schematic illustration of the process of exchanging gold for compensation in accordance with another preferred embodiment of the present invention.

### DETAILED DESCRIPTION

The present disclosure is directed to an improved system and method for redeeming gold for monetary consideration. While the present invention is described as intended for use in connection with the redemption or exchange of gold, it will be understood that the disclosed method and system can also be utilized for the redemption or exchange of other precious metals, such as silver, platinum, or the like. It will also be understood that the present invention may be utilized in connection with a variety of other valuable materials. Moreover, the method and system can take on a variety of different forms, some embodiments of which are discussed below.

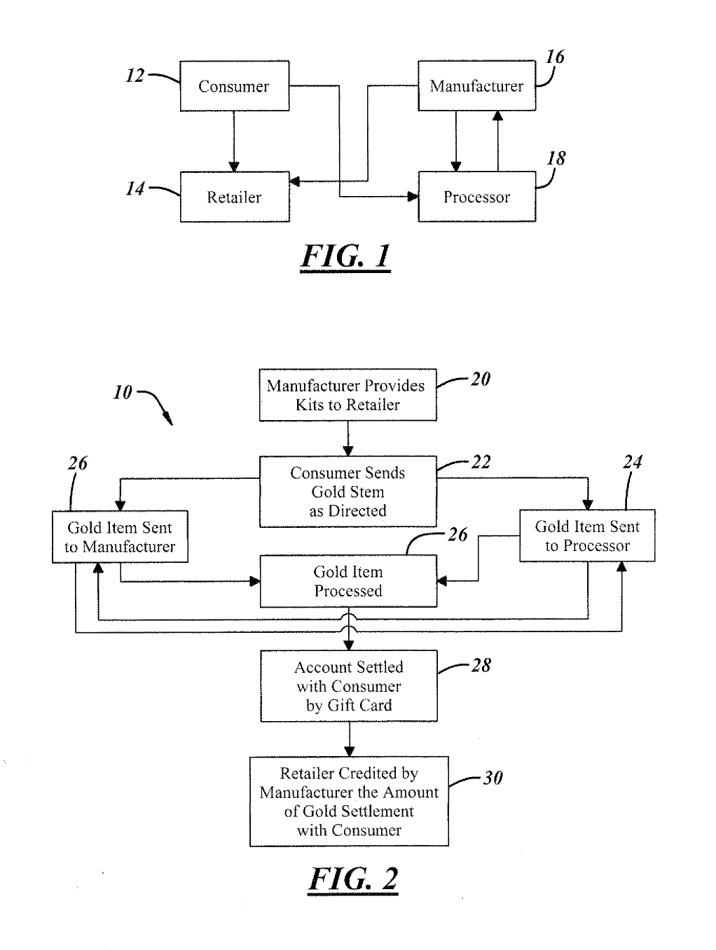

Referring now to FIG. 1, the system and method for redeeming gold for monetary consideration, generally referred to by reference number 10, preferably a multiple party transaction. The transaction preferably involves at least three parties, namely a consumer 12, a retailer 14, and a manufacturer 16. The consumer 12 is preferably an individual or other purchaser of goods. The retailer 14 is preferably a mass retailer that has multiple stores in different locations and also offers a variety of different goods in different areas. However, it will be understood that the retailer 14 can be any type of merchant of goods, as discussed in more detail below. Moreover, multiple retailers 14 can be part of the present invention at any given time. The manufacturer 16 can be any entity that has a use for the redeemed gold, such as a manufacturer of jewelry of other items that use gold. Alternatively, the manufacturer 16 can be an entity that processes and resells the gold to a manufacturer.

While the present invention preferably envisions a method and system that includes three parties, it will also be understood that more or less parties may be utilized as required. For example, as also shown in FIG. 1, in accordance with another preferred embodiment, the method and system also includes a third party processor 18, that is part of the transaction. As shown, the manufacturer 16 has a relationship or arrangement with the third party processor 18. Under this arrangement, the gold items are sent by the consumer 12 directly to the processor 18 instead of to the manufacturer 16. After the gold items are processed, as discussed in detail below, the processor 18 transfers the gold items to the manufacturer 16 in exchange for cash based on the value of the items.

Referring now to FIG. 2, which illustrates the steps in the method or system of redeeming gold for monetary consideration 10 in accordance with the present invention. As shown, the manufacturer 16 provides the retailer 14 with submission or processing kits for distribution to consumers 12 at its stores or facilities, as generally indicated by reference number 20. The kits are available for consumers 12 to take from the stores to facilitate submission of the gold items at the consumer's convenience. In a preferred embodiment, the manufacturer 16 has a business relationship with the retailer 14 such that the manufacturer 16 provides items, such as jewelry items, to the retailer 14 for resale in one or more of the retailer's facilities.

The gold kits preferably include information about the retailer, as well an identifier that is unique to each kit. The kits may also be preaddressed and include prepaid postage for the convenience of the consumer 12. One of the parties can have a relationship with a shipping company, such that they provide pre-printed labels for the kits, as will be understood by one of ordinary skill in the art. The kits are distributed by the retailer 14 to the consumers 12. In addition to providing the kits, the manufacturer 16 also preferably provides marketing materials, including point of sale marketing materials for display at the retailer's facility, which promotes the gold redemption program, i.e. the disclosed method and system. The manufacturer 16 may also provide training for salespeople of the retailer 14 to educate them as to how to promote and implement the program.

As generally indicated by reference number 22, the consumers 12 can take the submission kits from the retailer's facility to another location, such as their home. Once at their home or other suitable location, the consumer 12 can place the gold in an envelope that is part of the kit and deliver it according to the instructions that are part of the kit. According to the next step, the consumer 12 sends the gold item as directed by the instructions of the kit, as indicated by reference number 22.

In accordance with one embodiment, the kit containing the gold item is sent to the third party processor 18, as generally indicated by reference number 24. With this embodiment, the manufacturer 16 has an arrangement with the third party processor 18 where the processor 18 will be the addressee on the kits and physically receive the kits for processing. This allows the manufacturer 16 to remain anonymous or invisible with respect to the consumer 12. In an alternate embodiment, the kit containing the gold item is sent to the manufacturer 16 directly, as generally indicated by reference number 26. This eliminates the need for the third party processor 18. In either event, the guidelines for processing and evaluating the gold item are preferably set by the manufacturer 16.

Once the kit is received, the party that receives the kit, whether it be the manufacturer 16 or the processor 18, will open and process the gold item, as generally indicated by reference number 26. The steps of processing the gold item are briefly described below. Initially, in this embodiment, once the gold item is received by the processor 18, it is received and logged into a computer system. In accordance with a preferred embodiment, the computer system is networked between the manufacturer 16 and the processor 18. At this time, the computer system is programmed to automatically generate a notification for the consumer 12 that the gold item has been received. The notification is preferably sent to the consumer 12 by e-mail based on the information provided to the processor 18 in connection with the consumer's submission of the gold item with the kit. If the consumer 12 does not provide an e-mail address, the processor 18 will have to manually send the computer generated notification to the consumer 12. The computer system allows the gold item to be identified and tracked based on the information about the consumer 12. The computer system also allows the manufacturer 16 to track from what retailer 14 the consumer 12 obtained the kit, as discussed in more detail below.

Once the gold item has been received and logged into the computer system, it is then processed, including being subjected to the following steps: imaging, testing, and weighing. Based on this information, the processor 18 determines a monetary value for the gold item, which is referred to as the settlement value. In another embodiment where the gold item is sent directly to the manufacturer 16, it determines the settlement value for the gold item.

Once a monetary settlement value has been determined by the processor 18, this information is input into the computer system and associated with the information about the consumer 12. Thereafter, the computer system generates a settlement statement to inform the consumer 12 of the settlement value of the gold item they submitted. Preferably, this statement is sent out automatically by the computer system to the e-mail provided by the consumer 12 when they submitted the gold item for evaluation. Again, if no e-mail is provided, the processor 18 will call or otherwise contact the consumer 12 and advise them of the content of the settlement statement or otherwise transmit the settlement statement to the consumer 12. Alternatively, the responsibility for contacting the consumer 12 can be borne by the manufacturer 16.

The settlement statement provides an indication of the monetary settlement amount that the processor 18 is willing to provide to the consumer 12 in exchange for the gold item. The settlement statement also seeks direction from the consumer 12 as to how they would like to complete the transaction. Preferably, the settlement statement provides the consumer 12 with the following options to complete the transaction: 1) elect, within a selected period of time, i.e. thirty (30) days to have the gold item returned; 2) elect to receive cash for the gold item in the amount of the settlement value assigned to the gold item; or 3) elect to receive a gift card that can be used at the retailer 14 where the consumer 12 picked up the kit that contains the amount of the settlement value assigned to the gold item plus an additional amount. In accordance with a preferred embodiment, in order to entice people to select the gift card option, the processor 18 based on instructions from the manufacturer 16 adds additional predetermined monetary compensation to the gift card. Preferably, the manufacturer 16 increases the monetary compensation by an additional percentage, i.e. 10%. For example, if the gold item was valued by the processor 18 at $100.00 than if the consumer selected the gift card option, they would receive a gift card with $110.00 on it for use in one of the stores of the retailer 14 where the consumer 12 picked up the kit. It will be understood that a variety of other predetermined percentages could also be utilized.

If the consumer 12 elects to have the gold item returned, they can have it returned at no cost and this will be the end of the transaction. Alternatively, if the consumer 12 elects the second option, they can have a check sent to them or can be paid by other suitable means such as a wire transfer or a by pay pal. If the consumer 12 elects to receive the gift card, the retailer 14 is contacted and provided with the information about the consumer 12 so that the retailer 14 can issue the gift card in the appropriate amount. Additionally, instead of a gift card, store credit could also be provided to the consumer 12.

Accordingly, in a preferred embodiment, based on the settlement value, the manufacturer 16 or the processor 18 settles with the individuals 12 depending upon the option selected thereby. In accordance with the preferred system and method, if the consumer 12 does not elect to have the gold item returned, the manufacturer 16 then buys the gold from the processor 18 at minimal markup.

Preferably, on a monthly basis, the manufacturer 16 issues a summary to the retailer 14 that reflects the transactions that occurred that month for kits received from consumers 12 with gold items that originated at the retailer's store. The summary reflects a credit to the retailer 14 in an amount of the various settlement values issued to consumers 12, as generally indicated by reference number 30. For example, in one embodiment, the retailer 14 and the manufacturer 16 split the proceeds on a 50-50% basis. Thus, if the program generated $1000.00 in gold items for the manufacturer 16 and resulted in $1000.00 of monetary payments to consumers 12 then the month end statement would reflect a credit of $500.00 to the retailer 14. obviously, the proceeds can be split in a variety of other percentages. If the consumer 12 selects the gift card option and the manufacturer 16 agrees to give the consumer 12 an increased amount above the settlement value, the manufacturer 16 preferably absorbs the cost of the increased percentage and this is reflected in the month end summary as an additional credit to the retailer 14. Alternatively, the retailer 14 and the manufacturer 16 can utilize alternative credit arrangements

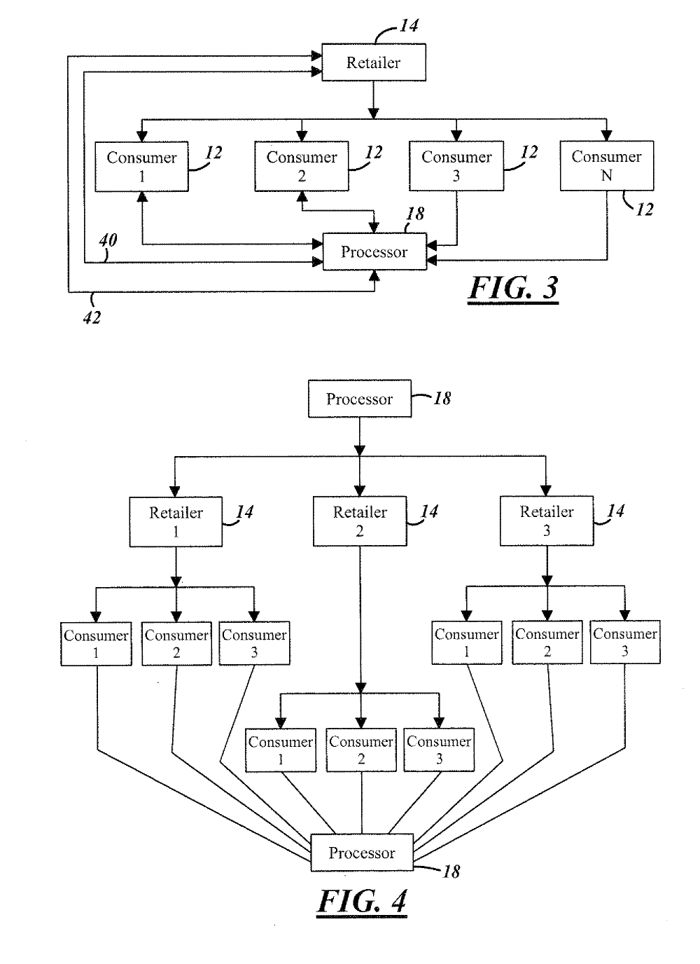

FIG. 3 schematically illustrates the operation of a preferred embodiment involving multiple consumers. As shown, the retailer 12 distributes kits for submission of gold items to a plurality of consumers 14. The number of consumers that receive kits is unlimited. The kits contain instructions that direct the consumers to submit the gold items to the processor 18.

It will be appreciated that not all consumers that obtain a kit from a retailer's facility will ultimately submit the kit with a gold item to the processor 18. Thus, the retailer 14 preferably sends information to the processor 18 about the number of kits that the retailer distributes, as generally indicated by reference number 40. The processor 18 can then determine based on the number of kits received what percentage of kits are submitted as compared to the number distributed. Additionally, after the gold items are received by the processor 18, and analyzed, the processor 18 communicates with the retailer 14, as generally indicated by reference number 42. The information communicated includes that the transaction has been completed. If the consumer 12 elected to receive a cash payout as monetary settlement for the gold, then a credit is issued to the retailer 14 in the amount of the monetary settlement or some other amount as agreed upon between the processor 18 and the retailer 14. Alternatively, if the consumer 12 elects to receive a gift card, this information is communicated to the retailer 14 so that they can issue the gift card to the consumer as well as the amount of the gift card to be issued to the consumer 12. Again, this is reflected as a credit or cash payment to the retailer 14 on a monthly, quarterly or other basis.

FIG. 4 illustrates another embodiment of the present invention. As shown, the processor 18 distributes kits to multiple retailers 14. It will be appreciated that the retailers can be multiple stores of the same company or can be different entities altogether. Each retailer 14 distributes the kits to multiple consumers 12 in the same manner as discussed above. Also, the consumers 12 submit their gold items to processor 18 in the same manner as discussed above. The processor 18 can also track from which retailer 14 the kit was obtained to ensure that the proper retailer 14 is given the appropriate credit for the gold item submitted.

While not shown specifically in FIGS. 3 and 4, it will be understood that the processor 18 can sell the gold items to another entity such as a manufacturer 16, as discussed above. Alternatively, the retailer can utilize the processor's service such that it appears that the retailer 12 has no control over the program and that it is entirely run by a third party, i.e. a private label service. As still another option, the processor 18 can set up a website for the retailer such as www.processor/retailer.com.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A method of exchanging a precious metal item for consideration, comprising:
providing a retailer with a plurality of submission kits for distribution to a plurality of consumers in at least one facility of said retailer such that said plurality of consumers can send in an item constructed of a precious metal in exchange for monetary consideration;
directing that said plurality of submission kits are transmitted to a third party;
processing said precious metal items transmitted with each of said plurality of submission kits;
determining a settlement value for each of said precious metal items;
transmitting said settlement value to said consumer that submitted said precious metal item;
providing said consumer with options as to how to complete said transaction, including a) return of said precious item, b) transmission of cash for said precious item; and c) transmission of a gift card in an amount at least as much as said settlement value for use at said retailer where said kit was obtained by said consumer;
receiving direction from said consumer as to which option said consumer desires to complete said transaction; and
completing said transaction

2. The method of claim 1, wherein said retailer is a mass retailer with multiple locations.

3. The method of claim 1, wherein said third part to whom said kits are submitted is a processor that processes, weighs and analyzes said precious metal item.

4. The method of claim 3, further comprising:
a manufacturer who has a business relationship with said retailer and who purchases said precious metal items from said third party processor.

5. The method of claim 1, wherein said precious metal items are constructed of gold.

6. The method of claim 1, wherein said gift card includes said settlement amount plus an additional amount.

7. The method of claim 6, wherein said additional amount includes a predetermined percentage of said settlement amount.

8. A method of exchanging precious metal items for monetary consideration, comprising:
promoting the exchange of precious metals for monetary consideration, including at a store of a retailer;
providing instructions to a consumer as to how to submit a precious metal item for evaluation;
receiving said precious metal item at a processing facility run by an entity different than said retailer;
entering information about said precious metal item into a computer system;
determining a settlement value for said precious metal item;
transmitting said settlement value to said consumer;
seeking instructions from said consumer as to how to complete the transaction; and
complying with instructions provided by said consumer to complete the transaction, including returning said precious metal item if directed by said consumer.

9. The method of claim 8, wherein said precious metal items are gold items.

10. The method of claim 8, further comprising:
automatically notifying said consumer that said precious metal item has been received via said computer system.

11. The method of claim 8, wherein the step of determining a settlement value for said precious metal item includes inspecting said precious metal item, weighing said precious metal item, and determining a precious metal content of said item.

12. The method of claim 8, wherein said consumer is provided with options as to how to complete the transaction, including 1) electing to have said precious metal item returned to said consumer; 2) electing to receive payment for said precious metal item in an amount equal to said settlement value; and 3) electing to receive a gift card for use at said store of said retailer.

13. The method of claim 12, wherein said gift card contains an amount that is greater than settlement value.

14. The method of claim 13, wherein said amount on said gift card is equal to said settlement value plus an additional amount equal to a predetermined percentage of said settlement value.
